(19) United States
(12) Patent Application Publication
(10) Pub. No.: US 2001/0032892 A1
(43) Pub. Date: Oct. 25, 2001

(54) Fire hose system having actively controllable multi-channel fire hose

(76) Inventors: David N. Brooks, Sicamous (CA); Melody M. Brooks, Sicamous (CA)

Correspondence Address: John S. Reid, 1926 S. Valleyview Lane, Spokane, WA, 99212-0157, US

(21) Appl. No.: 09/773,460

(22) Filed: Jan. 31, 2001

Related U.S. Application Data
(60) Provisional application No. 60/179,019, filed on Jan. 31, 2000.

(51) Int. Cl. B05B 15/00

(52) U.S. Cl. 239/450; 138/116

(57) ABSTRACT

The present invention includes a flexible multi-channel hose comprising a plurality of parallel channels extending longitudinally along the length of the hose. The first and second channels of the plurality of parallel channels are water conduits separated by a flexible partition. A third channel of the plurality of parallel channels is a service channel containing a flexible communication medium cooperating for signal communication between a remote signaling device on the hose and a regulator on a pumper. The signaling device may be mounted adjacent a nozzle end of the hose.

### CROSS REFERENCE TO RELATED APPLICATION

This application Claims priority from United States Provisional Patent Application No. 60/179,019 filed Jan. 31, 2000 titled Multi-Channel Fire Hose.

### FIELD OF THE INVENTION

This invention relates to the field of fire fighting equipment and in particular to an improved fire hose system which includes a hose having multiple water channels selectable and actively controllable by a firefighter operating the nozzle end of the hose.

### BACKGROUND OF THE INVENTION

Firefighting equipment and firefighting techniques have improved considerably over the last century. Firefights have become more aware of the environment in which they work, and subsequent improvements have been made to protect the firefighter in this hazardous environment. One area of improvement that has not changed however, is in the technology associated with the fire hose.

Currently, a firefighter picks one fire hose from the fire pumper. The hose is a single channel constant diameter hose. The diameters available to the firefighter will vary between fire departments, but will normally range between a 1 inch booster line and a 1¾ inch attack line. The larger the fire the firefighter needs to deal with, the bigger diameter line he selects. The firefighter is reluctant to select a larger diameter line than he needs because of the increased weight of the line, when full, that he has to pull. In use the firefighter pulls the line and stretches it out to eliminate kinks. He then signals the pump operator that his line can be charged with water. The firefighter now has to pull the fully charged line into the burning structure. The fully charged line weights up to 135 pounds per 100 feet of hose. The firefighter must drag the charged line over and around obstacles. In most cases, the fire hose needs to be dragged a fair distance to reach the source of the fire. When the firefighter reaches the fire, considerably fatigued, he will not have the ability of changing sizes of hoses or adjusting the pressure. Ile is committed to using the size of hose that ho initially pulled from the pumper.

The pump operator controls the supply of water and the pressure of the water supply. The firefighter has no control over the water pressure in the water supply or the water flow rate (the volume) of water filling the hose.

It is the object to overcome these disadvantages by providing a fire hose system that includes a hose that is divided into selectively usable channels. Several new functions are added to the traditional fire hose such as communications, emergency breathing air, and lighting.

In the prior art applicants are aware of Canadian Patent No. 2,114,253 which shows a collapsible hose having an inner and an outer tube with a gap in between and some flexible retainer members extending longitudinally of the inner and outer tubes, and U.S. Pat. No. 4,113,287 for End Fitting for Multi-Channel Hose, Canadian Patent No. 2,226,791 for Multiple Compartment Corrugated Hose and Patent No. FR 2697892 for Fuel Pipe With Three Coaxial Channels - Made From Coaxial Tubes and Radial Spacer Ribs, With Outer Tube Made From A Number Of Layers.

### SUMMARY OF THE INVENTION

The present invention includes a fire hose having a plurality of independently operable water channels and a service channel running the length of the hose. The firefighter at the nozzle end of the hose controls how many channels are to be charged at any one time, having operation of for example a nozzle control located on the nozzle end of the hose or for example by the mechanical positioning of a nozzle valve. The nozzle control or mechanical positioning of the nozzle valve cooperates, via a communication means which may be wires, fibre optics or the like in the service channel, with the regulator at the pumper outlet, For example, communication may also be accomplished by pulsed or selectively fluctuating changes in water or air pressure within the hose. Employing the fire hose system of the present invention the firefighter may thus enter the fire ground with only one channel in the hose filled with water, reducing the weight load of the hose by up to 50%. As fire conditions warrant, the firefighter operating the hose nozzle may increase the volume of water in the hose by filling an additional channel in the fire hose.

In an alternative embodiment, a second service channel may also serve as the conduit for the control wires/fibre optics. It may however also be used as a conduit for foam, water, or a combination of both. Further alternatively, air may be forced back into the water channels from the service channel so as to blow the water from one or more of the channels when the water requirements reduce or, for example, when it is desired to lighten the weight of the hose to more easily move around with the hose in the structure. The water may be blown back into the pumper's water tank. This effectively creates a self-draining fire hose which may be repeatedly drained and re-charged as need by the firefighter.

In use, the firefighter stretches the hose and pulls it along until he needs to change the hose. He then operates the nozzle controller or positions the nozzle valve to fill a channel or multiple channels of the hose with water. He has the option of filling only one channel to emulate a 1 inch booster line and that may be dragged over and around objects, at up to 50 percent less weight than a traditional attack line. As the firefighter approaches the fire, he then may choose to fill another channel of the hose to increase the volume of water. The pressure of the water in the hose may also be controlled by the firefighter via the nozzle controller by means of communications or controlling signals or commands for remote operation sent back to the regulator.

In summary the present invention includes a flexible multi-channel hose comprising a plurality of parallel channels extending longitudinally along thee length of the hose. The first and second channels of the plurality of parallel channels are water conduits separated by a flexible partition. A third channel of the plurality of parallel channels is a service channel containing a flexible communication medium cooperating for signal communication between a remote signaling device on the hose and a regulator on a pumper. The signaling device may be mounted adjacent a nozzle end of the hose.

The signaling device may be an electronically or mechanically operable controller for remote signaling of the regulator via the communication medium by an operator holding the controller and the nozzle end of the hose. The remote signaling is for instructing the regulator as to at least which of the first and second channels are to be charged with water from the pumper.

The service channel may also conduct pressurized air from the regulator to the controller.

A selectively operable valve on the service channel, operable by the controller, selectively directs the pressurized air into either the first channel or the second channel, either simultaneously or independently, so as to blow water in the first or second channels from the first or second channels.

The second channel may be resilient so that air directed under selective pressure into the second channel according to instructions from the controller will cause selective inflation or deflation of the second channel to thereby regulate water flow rate through the first channel. The air directed under selective pressure into the second channel may be the pressurized air from the service channel or pressurized air from the regulator.

The partition between the channels may be generally planar when the first and second channels are fully charged. The service channel may be mounted to the partition. Alternatively, where the plurality of parallel channels include a fourth channel, and the fourth channel is a third water conduit, the partition may comprise a plurality of radial partitions extending radially outwardly of a centered longitudinal axis of the hose. The service channel may be mounted along the centered longitudinal axis of the hose.

### BRIEF DESCRIPTION OF THE DRAWINGS

FIG. 1 is a lateral cross-section laterally across a segment of hose according to the present invention and such as indicated by line 1-1 in FIG. 2.

FIG. 2 is, in side elevation partially cut-away view, a hose coupling between segments of hose according to the present invention.

FIG. 3 is a partially diagrammatic illustration of 3 segments of hose according to the present invention extending between a pumper and a nozzle.

FIG. 4 is, in partially cut-away perspective view, one embodiment of the hose according to the present invention.

FIG. 5a is a farther embodiment of a hose according to the present invention seen in lateral cross-section.

FIG. 5b is the hose of FIG. 5a with one channel fully charged.

FIG. 5c is the hose of FIG. 5a with two water channels fully charged.

FIG. 6 is, in partially cut-away perspective view, a further embodiment of a hose according to the present invention.

FIG. 7 is, in lateral cross-section, a further embodiment of a hose according to the present invention.

FIG. 8 is, in partially cut-away side elevation view, a mechanical controller according to the present invention mounted at the nozzle end of a hose according to the present invention.

FIG. 9 is, in diagrammatic view, a regulator and hoses according to the present invention.

### DETAILED DESCRIPTION OF THE EMBODIMENTS OF THE INVENTION

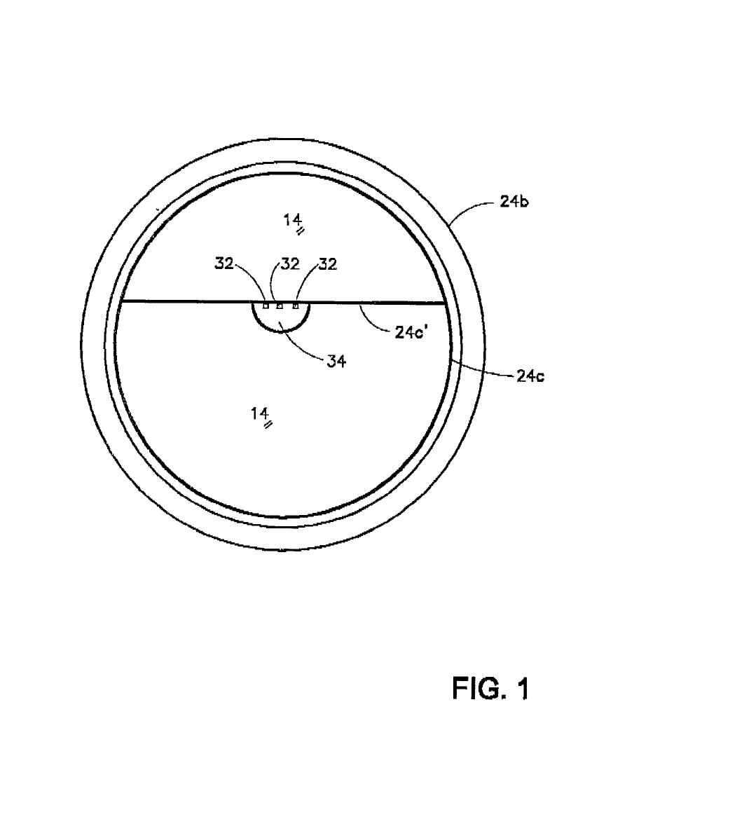

In the fire hose of the present invention, the hose may be divided into separate channels by one of several partition arrangements. Thus as seen in the example of FIG. 1, hose 10 is segmented longitudinally by flexible partitions 12 so as to form a corresponding plurality of independent sealed channels 14. Alternatively, other partition arrangements may be employed. For example, the partitioning may be altered to accommodate other hose partitions such as an air bladder/tubing insets, or an interior hose.

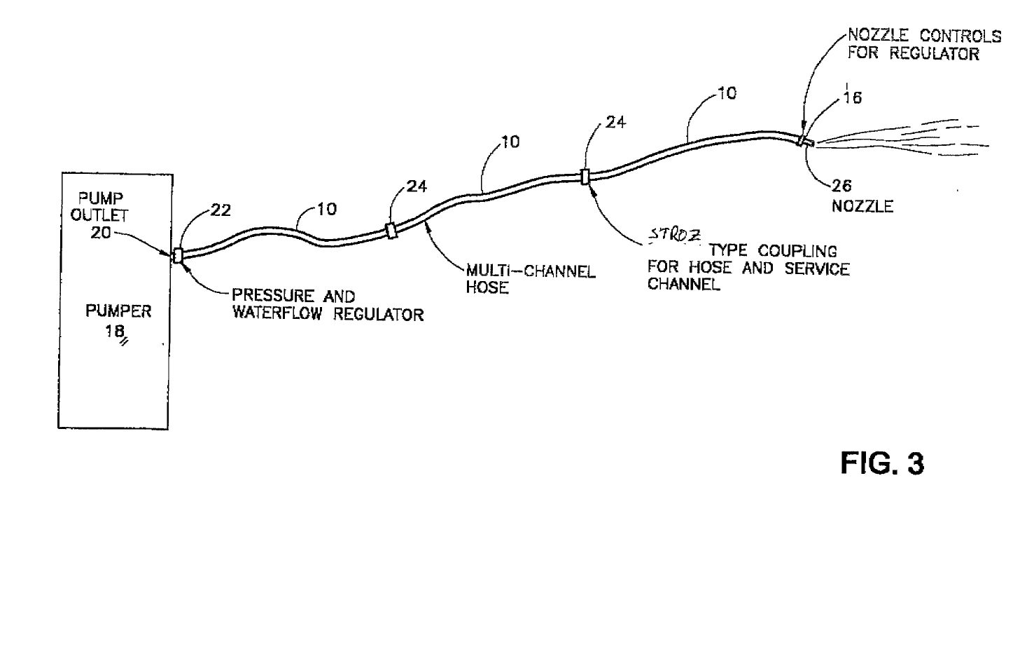

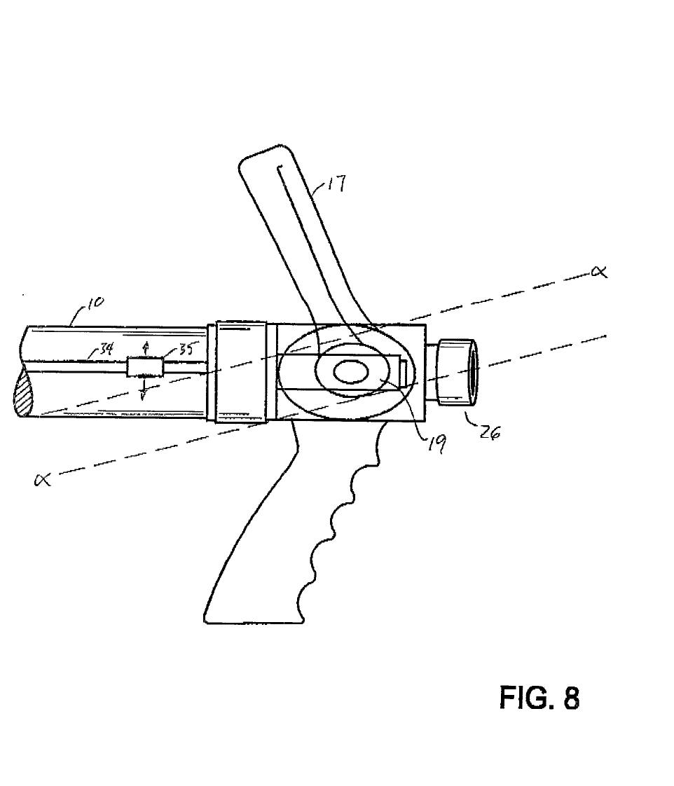

Water flows through selected channels as controlled by a nozzle mounted controller 16 or the mechanical positioning or a nozzle valve 19 such as seen in FIG. 8 on the nozzle end of hose 10 as also seen in FIG. 3. Thus water flows from pumper 18 via pump outlet 20 and pressure and water flow regulator 22 through segments of hose 10 joined by couplings 24.

The nozzle controller controls the functions of the system on demand by the firefighter at nozzle 26, and further controls air and water flow at the nozzle end of the hose. As water fills one channel from the regulator, the water must be prevented from filling another channel at the nozzle end of the hose. If the hose is already fully charged with water and part of the water volume is to be drained, the water flow is stopped at the regulator and the desired channel is emptied as well as at the nozzle controller. Pressurized air from a service channel 34 is directed into the hose channel to be drained to blow the water out of that segment of the hose. These functions may be done at the nozzle controller, at the nozzle itself, or a combination of the two. The valves that are used to control these functions may be low voltage electric, pneumatic valves (using air pressure from the system) or mechanical. Mechanical may be preferred as taking less space, and as being reliable, explosion proof, and requiring little maintenance. A modified ball valve and modified channeling of water is used with a traditional fire nozzle to allow for the flow of water. As the firefighter opens the nozzle to a first setting, one channel of water is flowing and no water can enter another channel. As the firefighter completely opens the nozzle, water from all channels may flow through. Each setting on the nozzle sends a signal back to the regulator to fill that channel with water.

Air manifold 35 directs air flow from service channel 34 into other channels 14 of the hose as required to blow desired portions of hose empty of water to decrease the weight in the hose. The manifold may also supply air to a SCBA connection for an emergency supply outlet of air for use by a firefighter. Air manifold 35 is controlled by nozzle controller 16 if electronic, or by angle of ball valve 19 if mechanical. Dotted lines α show the angle of a “two position” ball valve that allows for the flow or water from one water channel. The positioning of ball valve 19 also controls the filling and draining portions of the hose in a mechanical system.

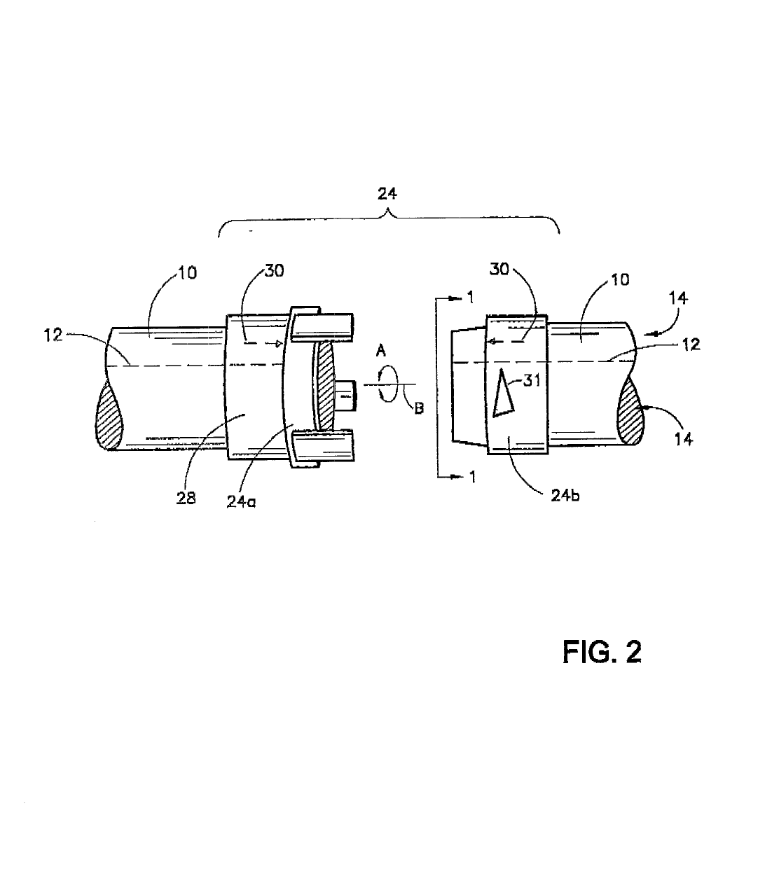

Couplings 24 may be modified stroz™ couplings having a female end coupling 24a and corresponding male end coupling 24b. Coupling 24 is modified in the sense that female end 24a advantageously is free to rotate independently of the segment of hose 10 to which it is mounted by means of coupling collar 28. Thus as seen in FIG. 2 female end 24a may be rotated in direction A about longitudinal axis B so as to releasably engage female coupling 24a to hub 31 of male coupling 24b without having to disturb the cooperating alignment of channels 14 between adjacent segments of hose 10. In conventional stroz™ couplers, the female end is rigidly mounted to the hose so that engaging and disengaging the female end of the corresponding male end of the coupling requires that the those segments be twisted relative to one another. Advantageously, a directional indicator 30 may be provided for example in either raised or lowered relief (shown in dotted outline) so as to indicate alignment of channels 14 between adjacent segments of hose 10.

In an alternative embodiment, the raised or lowered relief may be marked by the addition of a low voltage light or LED or fibre optic light that will illuminate to further indicate that a proper connection has been made. The color of the light may be used to indicate the coupling gender, such as blue for male and yellow for female. An additional advantage of a light on each side of the coupling, is that a disoriented firefighter may follow the hose out of the structure with greater ease and confidence. The firefighter would simply follow the direction of all the blue lights (male coupling) as this would be the direction to the fire pumper. Female end 24a may be scaled to male end 24b for example by use of modified O-ring 24c. O-ring 24c is modified to provide rubber cross members 24c to seal the variety of corresponding ends of partitions 12. Low voltage connection at the couplings is accomplished by a suitable connector, which effectively allows transmission of current and communication. Fibre Optics is connected by a suitable connector that allows for optical and electrical channels. Direct contact may not be required, as a beam may be transmitted from one side of the coupling and collected from the receiving side of the coupling.

Controller 16 is used by a firefighter holding the nozzle end of hose 10 to regulate a valve arrangement (not shown) for example located in pressure and water flow regulator 22. Controller 16 may communicate electrically with regulator 22 by means of electrical wires 32, or fibre optics (not shown) located in sealed service channel 34. In alternative embodiments, communication between the nozzle controller and the regulator may also be done by changes in air or water pressure within the hose. In a mechanical embodiment of the nozzle controller, the positioning of the nozzle handle 17 directs the volume of water from hose 10 and automatically communicates its position, and thus the desired water requirements to regulator 22. As illustrated, service channel 34 may be of much smaller size in cross section as compared to channels 14 so long as it is capable of providing a sealed conduit for wires 32 and in alternative embodiments to also provide a sealed conduit for fibre optics, foam or pressurized air as described above.

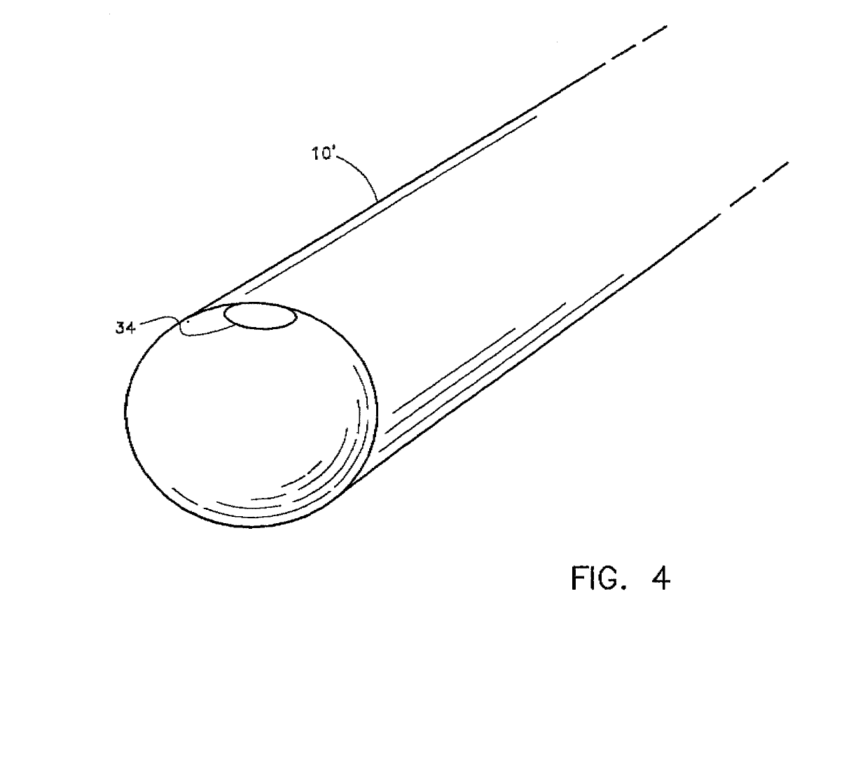

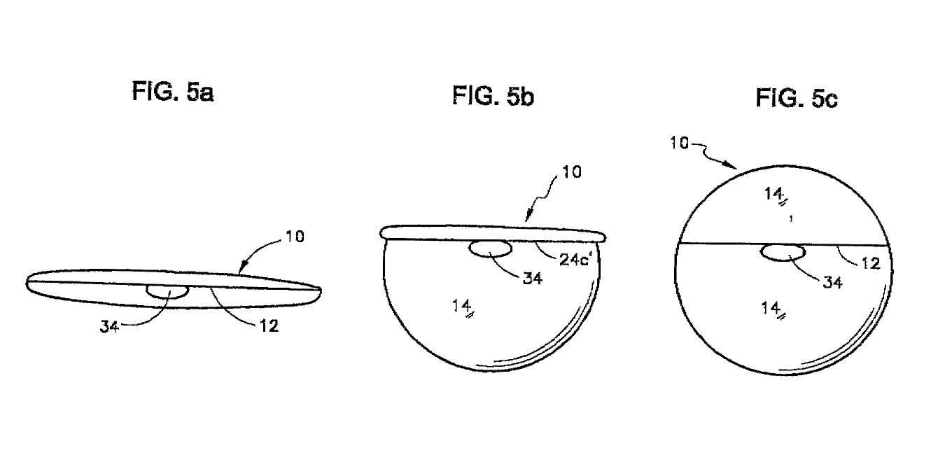

In the alternative embodiment of FIG. 4, a service channel 34 is mounted to the interior wall surface of an otherwise conventional hose 10. However in the embodiment of the present invention in which hose 10 has a plurality of channels 14, as better seen in FIGS. 5a-5c, when none of channels 14 are charged with water, hose 10 may be laid flat in the manner of conventional hoses. These drained hose segments preferably only weigh approximately 30 pounds per 100 feet of hose 10. When drained hose of FIG. 5a has a first channel 14 selected for use by a firefighter, hose 10 in cross section may take on the shape illustrated by way of example only in FIG. 5b. Thus in the example of FIG. 5b, a first channel 14 is charged with water to operate an equivalent to a 1 inch booster line at approximately 100 gallons of water per minute per 100 feet of hose, weighing when filled approximately 64 pounds per 100 feet.

Once the firefighter has maneuvered to a fire location requiring a larger volume of water, the firefighter operates controller 16 so as to charge a second channel 14 such as seen by way of example in FIG. 5c. The two fully charged channels 14 operate as the equivalent of a 1½ inch diameter attack line providing approximately 150 gallons per minute and weighing approximately 110 pounds per 100 feet of hose.

The diameter of fire hoses that may be used in the manner of this invention is not limited to a 1½ in diameter hose. The greatest benefit is achieved by the use of larger diameter hoses, from 1½ to 2½ attack lines,

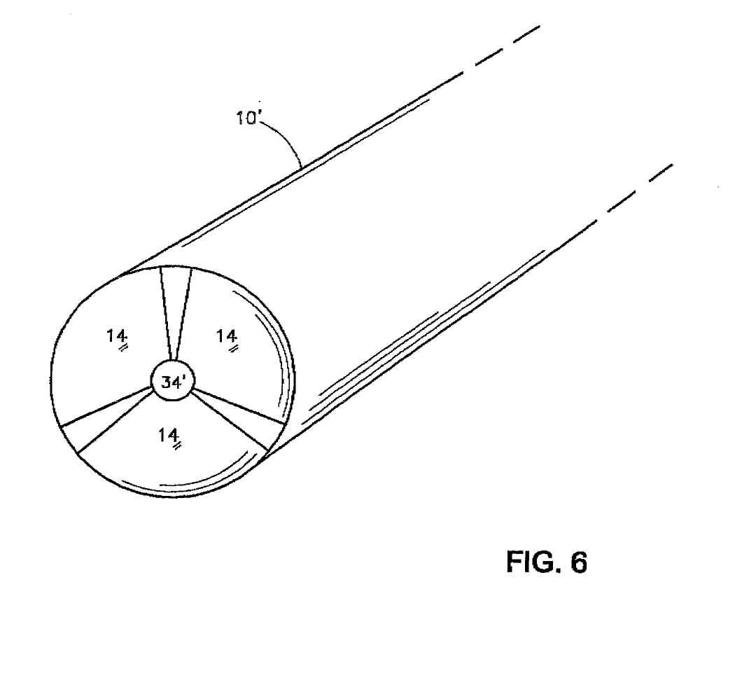

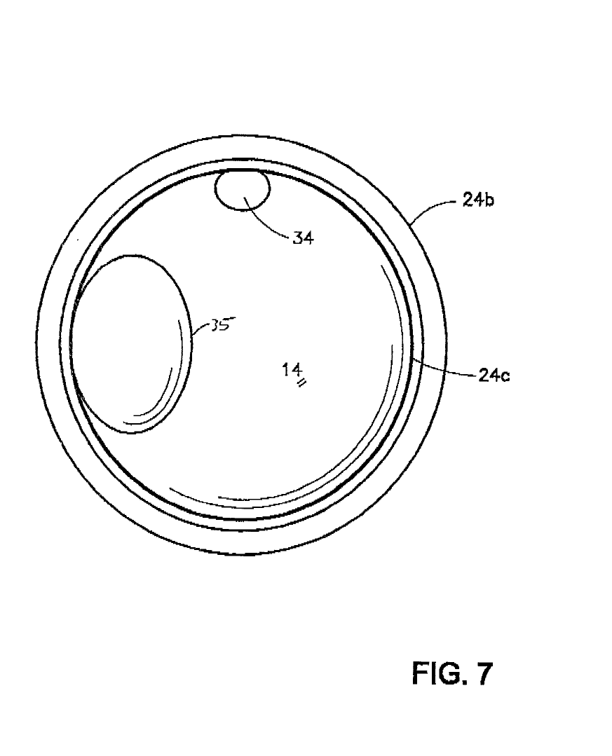

The cross-sectional layouts of FIG. 5 are not intended to be limiting as, for example, a greater or lesser number of channels 14 may be provided, or the channels may be arranged as, for example, a radially segmented hose having radially segmented channels 14 as seen in FIG. 6.

A further advantage of this invention is the ability to have emergency breathing air for example supplied through service channel 34, lighting, man down alarm and communication and lighting means located at the nozzle end of the fire hose.

In a further air bladder/tubing embodiment, an air bladder or resilient or flexible tubing 35 inside of the hose allows air pressure to expand or shrink the bladder thereby directly affecting the volume of water in the water channel portion of the hose in which the bladder/tubing is mounted. If the nozzle operator requires less water and reduction of hose weight, the air volume in the air bladder/tubing, is increased thereby reducing the volume of water in the water channel of the hose. The advantage of this design is that a bladder/tubing may be inserted into existing fire hoses. Another advantage of this design is that there is no additional friction loss over a comparable size hose.

A further alternative design uses a second hose that is inserted into a larger hose, thereby effectively giving two channels for water flow. The smaller diameter hose is filled with water when the nozzle operator requires a minimal flow and a reduction in hose weight. When there is an additional requirement for increase in volume of water, the larger hose is filled with water to deliver the maximum volume of water to the nozzle operator. The advantage to this design is that the interior hose could be inserted into an existing fire hose.

As mentioned above, in one embodiment fibre optics may, without intending to be limiting, be used for the following functions: (a) control functions between the nozzle controller and the regulator at the pump outlet; (b) communications from the nozzle operator through the hose, which includes but is not limited to voice, signals, and man down alarms; and, (c) lighting at the end of the hose to assist the nozzle operator with visibility. The control functions and the communications are accomplished by very tightly focused digital pulses of light through the optical fibres as would be known to one skilled in the art of fibre optic communications.

The fibre optic lighting requires three components; namely a light driver, a fibre optic harness and light fittings. The light driver is the light source. Projection of light into the fibre catchment is done back at the fire pumper. The fibre optic harness carries the light from the light driver to through-tubes using the principle of total internal reflection. The fibre optic harness is located inside the fire hose to protect the harness, and may be located in the service channel. The light fittings are light outlets that control and direct the light to the task. These light outlets may be located, but are not limited, to the front face of the nozzle. The water stream is used as an advantage for directing the lighting.

The benefits of the use of fibre optics and optical fibres include that:

a) The strands are the size of a strand of hair which take less room inside of a fire hose, allowing for more water capacity,

b) Multiple light fittings can be illuminated from the one light driver. This allows for multiple light fittings at the front face of the nozzle and allows for an illuminated light signal at the couplings to indicate a complete connection of the fibre optics and optical fibres.

(e) There is no heat at the end of the fibre optics or optical fibres which prevents the hazard of a heat source being introduced into an explosive environment.

d) There is no electricity or low voltage current throughout the fibre optic harness and light fittings which prevents the hazard of an electrical source being introduced into an explosive environment.

e) There is no maintenance of the fibre optics, optical fibres, or the light fittings.

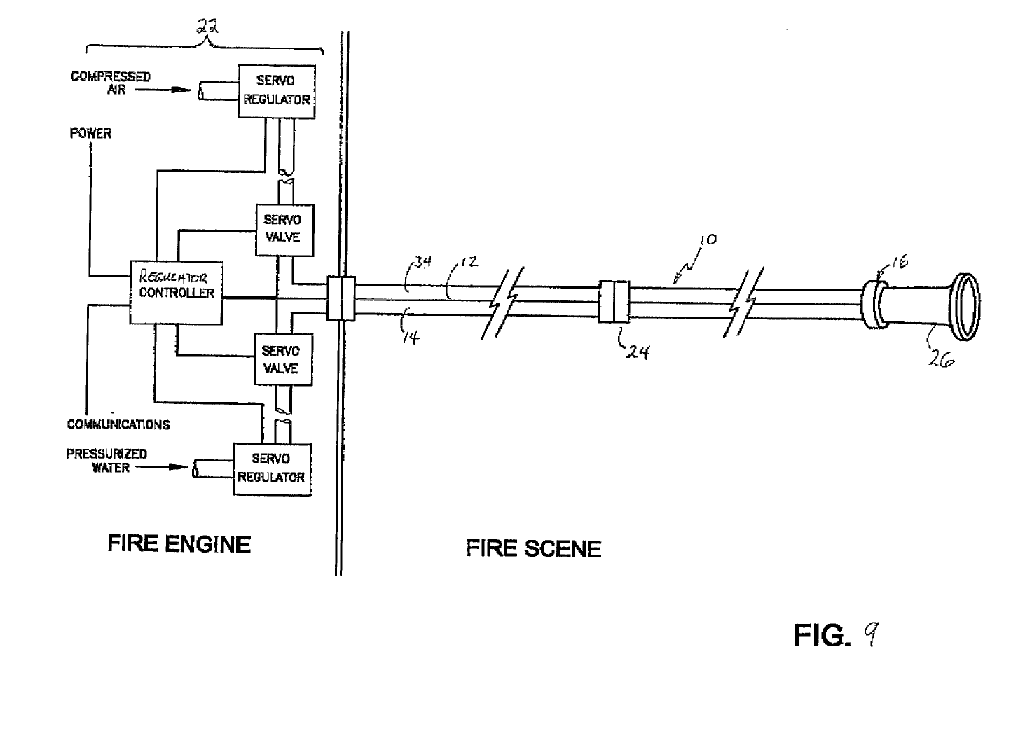

FIG. 9 is a schematic of regulator 22 and how it interfaces with controller 16. Regulator 22 performs all or some of the following functions:

a) Control air flow.

b) Control water flow into channels.

c) Control pressure.

d) Re-direct waste water to tank of fire pumper.

e) Act as a gathering area for electronic wire, fibre optics, optical fibre, prior to entry into hose.

As will be apparent to those skilled in the art in the light of the foregoing disclosure, many alterations and modifications are possible in the practice of this invention without departing from the spirit or scope thereof. Accordingly, the scope of the invention is to be construed in accordance with the substance defined by the following claims.

What is claimed is:

1. A flexible multi-channel hose comprising a plurality of parallel channels extending longitudinally along the length of said hose wherein first and second channels of said plurality of parallel channels are water conduits separated by a flexible partition and a third channel of said plurality of parallel channels is a service channel containing a flexible communication medium cooperating for signal communication between a remote signalling device on said hose and a regulator on a pumper, said signalling device mounted adjacent a nozzle end of said hose.

2. The apparatus of claim 1 wherein said signalling device is an electronically operable controller for remote signalling of said regulator via said communication medium by an operator holding said controller and said nozzle end of said hose, said remote signalling for instructing said regulator as to at least which of said first and second channels are to be charged with water from said pumper.

3. The apparatus of claim 2 wherein said service channel also conducts pressurized air from said regulator to said controller.

4. The apparatus of claim 3 wherein a selectively operable valve on said service channel, operable by said controller, selectively directs said pressurized air into either said first channel or said second channel, either simultaneously or independently, so as to blow water in said first or second channels from said first or second channels.

5. The apparatus of claim 4 wherein said second channel is resilient so that air directed under selective pressure into said second channel according to instructions from said controller will cause selective inflation or deflation of said second channel to thereby regulate water flow rate through said first channel, and wherein said air directed under selective pressure into said second channel may be said pressurized air from said service channel or pressurized air from said regulator.

6. The apparatus of claim 4 wherein said partition is generally planar when said first and second channels are fully charged, and said service channel is mounted to said partition.

7. The apparatus of claim 4 wherein said plurality of parallel channels include a fourth channel, said fourth channel being a third water conduit, and wherein said partition comprises a plurality of radial partitions extending radially outwardly of a centered longitudinal axis of said hose.

8. The apparatus of claim 7 wherein said service channel is mounted along said centered longitudinal axis of said hose.

9. The apparatus of claim 2 wherein said communication medium is electrically conductive wiring.

10. The apparatus of claim 2 wherein said communication medium is fibre optic conductors.

11. The apparatus of claim 1 wherein said signalling device is a mechanically operable controller for remote signalling of said regulator via said communication medium by an operator holding said controller and said nozzle end of said hose, said remote signalling for instructing said regulator as to at least which of said first and second channels are to be charged with water from said pumper.

12. The apparatus of claim 11 wherein said service channel also conducts pressurized air from said regulator to said controller.

13. The apparatus of claim 12 wherein a selectively operable valve on said service channel, operable by said controller, selectively directs said pressurized air into either said first channel or said second channel, either simultaneously or independently, so as to blow water in said first or second channels from said first or second channels.

14. The apparatus of claim 13 wherein said second channel is resilient so that air directed under selective pressure into said second channel according to instructions from said controller will cause selective inflation or deflation of said second channel to thereby regulate water flow rate through said first channel, and wherein said air directed under selective pressure into said second channel may be said pressurized air from said service channel or pressurized air from said regulator.

15. The apparatus of claim 13 wherein said partition is generally planar when said first and second channels are fully charged, and said service channel is mounted to said partition.

16. The apparatus of claim 13 wherein said plurality of parallel channels include a fourth channel, said fourth channel being a third water conduit, and wherein said partition comprises a plurality of radial partitions extending radially outwardly of a centered longitudinal axis of said hose.

17. The apparatus of claim 16 wherein said service channel is mounted along said centered longitudinal axis of said hose.

18. The apparatus of claim 11 wherein said communication medium is electrically conductive wiring.

19. The apparatus of claim 11 wherein said communication medium is fibre optic conductors.
